(19) United States
(12) Patent Application Publication
(10) Pub. No.: US 2011/0222761 A1
(43) Pub. Date: Sep. 15, 2011

(54) METHOD AND SYSTEM FOR PRESERVING THE CREATIVE INTENT WITHIN AN IMAGE PRODUCTION CHAIN

(75) Inventor: John S. Haikin, Fremont, CA (US)

(73) Assignee: CANON KABUSHIKI KAISHA, Tokyo (JP)

(21) Appl. No.: 12/721,481

(22) Filed: Mar. 10, 2010

(51) Int. Cl. G06K 9/36; G06F 17/30

(52) U.S. Cl. 382/162; 707/756; 707/741; 707/E17.031; 707/E17.045; 707/E17.002

(57) ABSTRACT

Capturing complex artistic intent for an image having image data for multiple pixels. Plural look algorithms are defined, where each look algorithm applies color adjustments to one or more colors to produce corresponding output colors. An artistic intent is identified for each pixel of the image, where the artistic intent is constituted by chained application of one or more of the look algorithms. Information identifying the artistic intent for each pixel of the image is stored in a format that stores the artistic intent identification information together with the image data for each pixel of the image.

### FIELD

The present disclosure relates to a complex creative intent in still or moving imagery, and more particularly relates to a complex creative intent within an image production chain.

### BACKGROUND

In a studio environment for the production of still and moving images, an artist typically creates a still or moving image with an underlying artistic vision in mind. This artistic vision is often referred to as a look or a creative intent.

A creative intent may be complex, in that the still or moving image may contain different elements, each of which is considered to have its own look. In this case, the artist may create a complex look based on multiple different looks for different elements in the image. Additionally, an image may contain multiple looks in a situation where multiple images are combined into a single image. For example, in the motion picture industry, it is common for special effects to be created in separate studios and combined during a post production process.

In some cases, the still or moving image is created with a target medium in mind, but is redistributed using an alternate technology. For example, a photograph may be originally intended for printing on paper, but may be retargeted for display on a computer monitor. In the case of moving imagery, the original moving imagery may be intended for viewing in a movie theater, but may also be distributed via DVD for viewing on a television at a personal residence.

### SUMMARY

In the course of the production of still and moving imagery, the images are typically put into a production chain where it is expected that changes will be made subsequent to the initial capture of the image. In this situation, subsequent workers in the production chain may not have knowledge of the artist's creative intent for the image, such that the creative intent may be altered or lost. Furthermore, in the case that an image contains different elements with multiple different looks, the complex artistic intent for each element in the image may be altered or lost.

Moreover, the complex artistic intent may be altered or lost due to the alteration of the image colors within the production chain. More specifically, it may become necessary to alter the colors of the image for a number of reasons, including, for example, in order to meet reduced color availability in a target output device. This may occur, for example, in a situation where a digitally-captured frame of moving imagery is reproduced into a movie poster.

The foregoing situation is addressed through the identification of an artistic intent for each pixel of an image, and storage of information identifying the artistic intent for each pixel of the image in a format that stores the artistic intent identification information together with the image data for each pixel of the image.

Thus, in an example embodiment described herein, a complex artistic intent is captured for an image having image data for multiple pixels. Plural look algorithms are defined, where each look algorithm applies color adjustments to one or more colors to produce corresponding output colors. An artistic intent for each pixel of the image is identified, where the artistic intent is constituted by chained application of one or more of the look algorithms. Information identifying the artistic intent for each pixel of the image is stored in a format that stores the artistic intent identification information together with the image data for each pixel of the image.

By virtue of this arrangement, it is ordinarily possible to preserve a complex artistic intent for an image, such that the complex artistic intent is preserved within an image production chain. Furthermore, since plural look algorithms are defined, it typically becomes possible to take advantage of future technologies which are not currently available. For example, a look algorithm can be defined which produces output colors which are not currently capable of being represented by a particular output device. In this way, if colors which are not currently available become available through future developments, such colors will be rendered for the output device.

In an example embodiment also described herein, a module for using complex artistic intent for an image having image data for multiple pixels is provided. Plural look algorithms are defined, and each look algorithm applies color adjustments to one or more colors to produce corresponding output colors. An artistic intent for each pixel of the image is identified, and the artistic intent is constituted by chained application of one or more of the look algorithms. Information identifying the artistic intent for each pixel of the image is stored in a format that stores the artistic intent identification information together with the image data for each pixel of the image. The module includes an appearance module constructed to convert color information of each pixel of the image to a color appearance value. An extraction module is constructed to extract the stored information identifying the artistic intent for each pixel of the image. An execution module is constructed to execute the one or more look algorithms constituting the artistic intent for each corresponding pixel, and the look algorithms apply color adjustments to the color appearance value of each corresponding pixel to produce corresponding output colors. An output module is constructed to convert the corresponding output colors to colors that can be represented in a specified output device.

In some example embodiments, the image is accessed, pixels of the image are identified, and the artistic intent is selected and assigned to each identified pixel of the image.

In one example embodiment, the image is edited, and during editing the artistic intent identification information stored for each pixel is used to modify the color of each such pixel. In other embodiments, the artistic intent identification information stored for each pixel is modified during editing.

In some embodiments, the image is rendered for a specified output device, and during rendering colors in the image are converted to colors that can be represented in the specified output device by reference to the artistic intent identification information stored for each pixel in the image, so as to preserve artistic intent on the specified output device.

In one example embodiment, the image is one frame among multiple frames of a moving image, and each of the multiple frames has image data for multiple pixels. In this situation, pixels for an object that appears across multiple frames of the moving image are designated, and the same artistic intent is identified for all such pixels. Additionally, there are multiple different objects that appear across multiple frames of the moving image, and a different artistic intent is identified for each object.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a representative view of computing equipment relevant to one example embodiment.

FIG. 2 is a detailed block diagram depicting the internal architecture of the first host computer shown in FIG. 1.

FIG. 3 is a detailed block diagram depicting the internal architecture of the second host computer shown in FIG. 1.

FIG. 4 is a detailed block diagram depicting the internal architecture of the third host computer shown in FIG. 1.

FIG. 5 is a view for explaining software architecture of a look algorithm editor module according to an example embodiment.

FIG. 6 is a view for explaining software architecture of an image editor module according to an example embodiment.

FIG. 7 is a representational view of processing performed by an image editor module according to an example embodiment.

FIG. 8 is a view for explaining software architecture of modules for using complex artistic intent according to an example embodiment.

FIG. 9 is a flow diagram for explaining capturing complex artistic intent for an image according to an example embodiment.

FIG. 10 is a flow diagram for explaining using complex artistic intent for an image according to an example embodiment.

### DETAILED DESCRIPTION

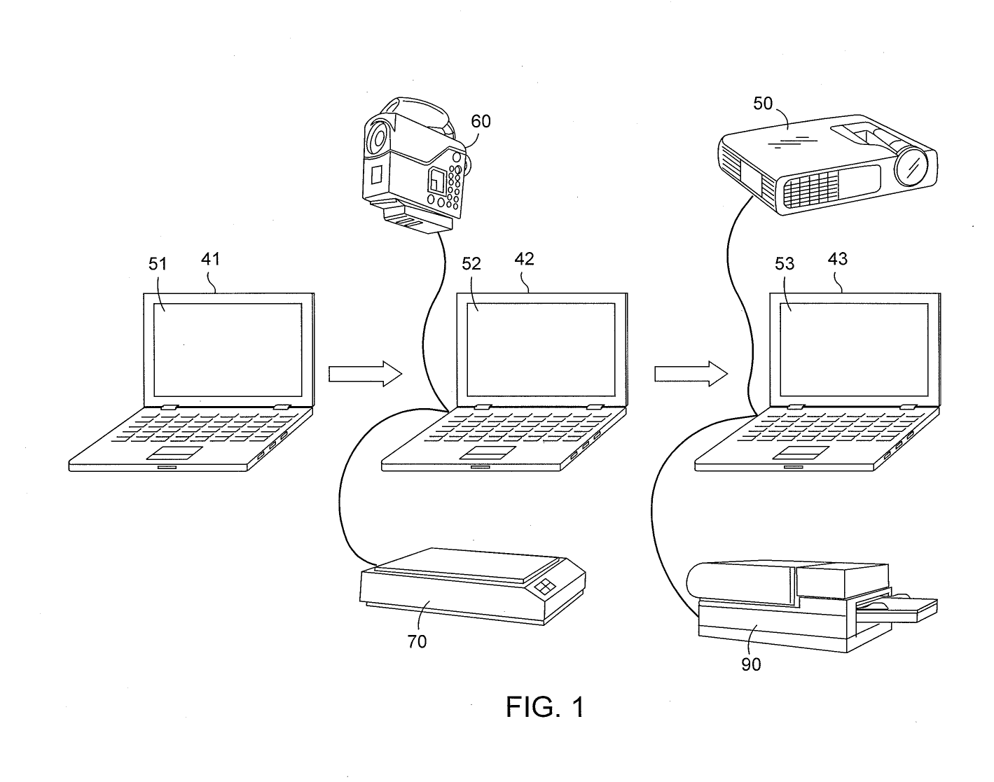

FIG. 1 is a representative view of computing equipment, peripherals and digital devices, relevant to one example embodiment. The computing equipment includes first host computer 41, second host computer 42 and third host computer 43.

First host computer 41 generally comprises a programmable general purpose personal computer (hereinafter “PC”) having an operating system such as Microsoft® Windows® or Apple® Mac OS® or LINUX, and which is programmed as described below so as to perform particular functions and in effect to become a special purpose computer when performing these functions. Host computer 41 also includes a color monitor including display screen 51, a keyboard for entering text data and user commands, and a pointing device. The pointing device preferably comprises a mouse for pointing and for manipulating objects displayed on display screen 51.

Host computer 41 also includes computer-readable memory media such as a computer hard disk and a DVD disk drive, which are constructed to store computer-readable information such as computer-executable process steps. The DVD disk drive provides a means whereby host computer 41 can access information, such as image data, computer-executable process steps, application programs, etc. stored on removable memory media. In an alternative, information can also be retrieved through other computer-readable media such as a USB storage device connected to a USB port (not shown), or through a network interface. Other devices for accessing information stored on removable or remote media may also be provided.

Second host computer 42 generally comprises a programmable general purpose personal computer (hereinafter “PC”) having an operating system such as Microsoft® Windows® or Apple® Mac OS® or LINUX, and which is programmed as described below so as to perform particular functions and in effect to become a special purpose computer when performing these functions. Host computer 42 also includes a color monitor including display screen 52, a keyboard for entering text data and user commands, and a pointing device. The pointing device preferably comprises a mouse for pointing and for manipulating objects displayed on display screen 52.

Host computer 42 also includes computer-readable memory media such as a computer hard disk and a DVD disk drive, which are constructed to store computer-readable information such as computer-executable process steps. The DVD disk drive provides a means whereby host computer 42 can access information, such as still or moving image data, computer-executable process steps, application programs, etc. stored on removable memory media. In an alternative, information can also be retrieved through other computer-readable media such as a USB storage device connected to a USB port (not shown), or through a network interface. Other devices for accessing information stored on removable or remote media may also be provided.

Digital color video camera 60 is a first example of a color input device, and is provided for sending digital image data to host computer 42. In this embodiment, digital color video camera 60 is a digital cinematography camera which captures moving digital image data.

Digital color scanner 70 is a second example of a color input device, and is provided for scanning images and sending the corresponding image data to host computer 42. In some embodiments, digital color scanner 70 is a motion picture film scanner which scans film negatives into a digital format.

Of course, host computer 42 may acquire digital image data from other sources such as a digital camera, a local area network or the Internet via a network interface. Likewise, host computer 42 may interface with other color output devices, such as color output devices accessible over the network interface.

Third host computer 43 generally comprises a programmable general purpose personal computer (hereinafter “PC”) having an operating system such as Microsoft® Windows® or Apple® Mac OS® or LINUX, and which is programmed as described below so as to perform particular functions and in effect to become a special purpose computer when performing these functions. Host computer 43 also includes a color monitor including display screen 53, a keyboard for entering text data and user commands, and a pointing device. The pointing device preferably comprises a mouse for pointing and for manipulating objects displayed on display screen 53.

Host computer 43 also includes computer-readable memory media such as a computer hard disk and a DVD disk drive, which are constructed to store computer-readable information such as computer-executable process steps. The DVD disk drive provides a means whereby host computer 43 can access information, such as image data, computer-executable process steps, application programs, etc. stored on removable memory media. In an alternative, information can also be retrieved through other computer-readable media such as a USB storage device connected to a USB port (not shown), or through a network interface. Other devices for accessing information stored on removable or remote media may also be provided.

Projector 50 is a first example of a color output device, and in this example is an RGB or RGBW projector, such as a DLP™ digital projector or other display device that projects still or moving images in accordance with image data from host computer 43 onto a projection screen (not shown). Projector 50 may be an HDR device which projects HDR images. Projector 50 projects still or moving images onto a display screen (not shown) by using additive light combinations of red (R), green (G) and blue (B) colorant lights. In addition, and particularly in a case of an HDR device, projector 50 also uses a white (W) light so as to increase the brightness/luminance of projected images and thereby project HDR images with good fidelity over a large dynamic range.

Printer 90 is a second example of a color output device, and in this example is a color laser printer which forms color images on a recording medium such as paper or transparencies or the like. Printer 90 forms color images using cyan, magenta, yellow and black colorants, although printers and other devices can be used which form color images using other colorant combinations that might or might not include black, such as a CMYKOG device.

A third example of a color output device is a film recorder (not shown), which is used to print still or moving digital image data to film.

Together, host computers 41 to 43 represent one example of an image production chain in which it is expected that changes will be made to a moving or still image subsequent to its initial capture. More specifically, each host computer performs one or more various roles in the production chain. These roles include, for example, defining plural artistic intent algorithms, identifying an artistic intent for each pixel of an image and storing information identifying the artistic intent for each pixel of the image together with the image data for each pixel of the image, and using the complex artistic intent to render the image. In addition, in some example embodiments, the host computers edit the image using various editing and coloring tools, such as during post-production of a movie or during the creation of a digital intermediate. Such editing includes, for example, color grading, visual effects or editorial assembly. These various roles will be explained in more detail below.

In other example embodiments, there are any number of host computers within the image production chain. Of course, one or more of the various roles can be performed by a single host computer, or alternatively, the roles may be distributed in any suitable way amongst the host computers in the image production chain.

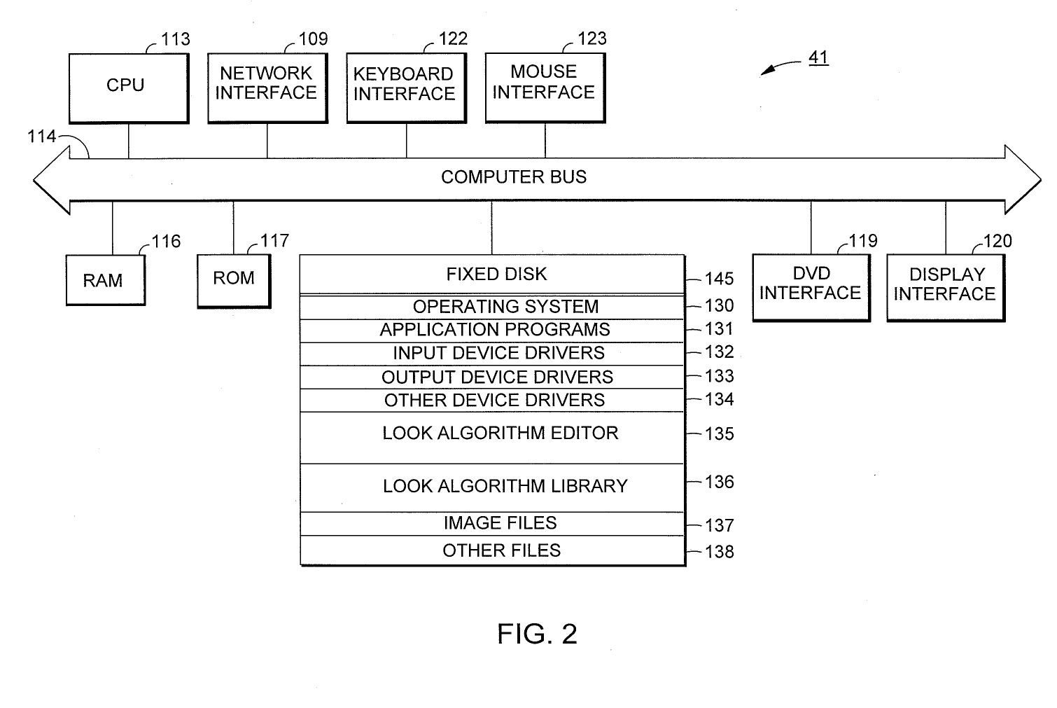

FIG. 2 is a detailed block diagram showing the internal architecture of first host computer 41. As shown in FIG. 2, first host computer 41 includes central processing unit (CPU) 113 which may be a multi-core CPU and which interfaces with computer bus 114. Also interfacing with computer bus 114 are hard disk 145, network interface 109, random access memory (RAM) 116 for use as a main run-time transient memory, read only memory (ROM) 117, DVD disk interface 119, display interface 120 for display screen 51, keyboard interface 122 for a keyboard, and mouse interface 123 for a pointing device.

RAM 116 interfaces with computer bus 114 so as to provide information stored in RAM 116 to CPU 113 during execution of the instructions in software programs such as an operating system, application programs, color management modules, and device drivers. More specifically, CPU 113 first loads computer-executable process steps from fixed disk 145, or another storage device into a region of RAM 116. CPU 113 can then execute the stored process steps from RAM 116 in order to execute the loaded computer-executable process steps. Data such as color images or other information can be stored in RAM 116, so that the data can be accessed by CPU 113 during the execution of computer-executable software programs, to the extent that such software programs have a need to access and/or modify the data.

As also shown in FIG. 2, fixed disk 145 contains computer-executable process steps for operating system 130, and application programs 131, such as graphic image management programs and other editing and coloring tools. Fixed disk 145 also contains computer-executable process steps for device drivers for software interface to devices, such as input device drivers 132, output device drivers 133, and other device drivers 134. Image files 137, including color image files, and other files 138 are available for output to color output devices and for manipulation by application programs.

Fixed disk 145 also contains computer-executable process steps for look algorithm editor 135 and look algorithm library 136. Look algorithm editor 135 is constructed to define plural look algorithms, each of which comprises computer-executable process steps for applying color adjustments to one or more colors to produce corresponding output colors. The look algorithms are stored in look algorithm library 136, and this set of look algorithms forms the basis for preserving complex artistic intent of the image. In this embodiment, each look algorithm is encoded as a sequence of instructions which can be directly executed by a computer. Alternatively, a compiler can be provided in order to compile the look algorithm before storing it in look algorithm library 136. Furthermore, each look algorithm can be encoded as instructions in an interpretive language, or represented as a 3D lookup table (LUT). Interpretive languages include, for example, Basic, .Net, Lua, and Color Transform Language (CTL).

In this embodiment, each look algorithm supports any suitable input color used in the still or motion picture domain, and outputs colors that correspond to an artistic intent for a pixel of the image. Colors input to each look algorithm and output from each look algorithm are encoded in a color appearance space which is device independent. Colors in appearance space are sometimes represented by hue, lightness and chroma.

As one example, a look algorithm is defined which makes face colors appear more red. In this case, the look algorithm determines whether an input color is a face color by analyzing color data of a pixel of an input image represented in appearance space. For example, if the hue of the input color is between 49 degrees and 77 degrees, and the lightness is between 69 and 75, and the chroma is between 31 and 35, then it is determined that the color of the pixel represents a face color. In this case, the amount of red for that pixel is increased by, for example, 10%. The amount of red is increased by shifting the hue of the color. This shifting is done, for example, by subtracting 30% from the input hue to produce the output hue. On the other hand, if the input color is not a face color, the algorithm indicates that no change is made.

As a second example, a look algorithm is defined which adjusts the colors of a pixel such that details in a shadowed area of the image are preserved. Of course, these examples are provided for purposes of explanation only, and those having ordinary skill in the art will appreciate that any number of look algorithms can be defined having a wide range of capabilities.

The computer-executable process steps for look algorithm editor 135 and look algorithm library 136 may be configured as a part of operating system 130, as part of a device driver, or as a stand-alone application program such as a look management system. They may also be configured as a plug-in or dynamic link library (DLL) to the operating system, device driver or application program. For example, look algorithm editor 135 and look algorithm library 136 according to example embodiments may be incorporated in an output device driver for execution in a computing device, such as a printer driver, embedded in the firmware of an output device, such as a printer, or provided in a stand-alone look management application for use on a general purpose computer. In one example embodiment described herein, look algorithm editor 135 and look algorithm library 136 are incorporated directly into the operating system for first host computer 41. It can be appreciated that the present disclosure is not limited to these embodiments and that the disclosed modules may be used in other environments in which artistic intent is used.

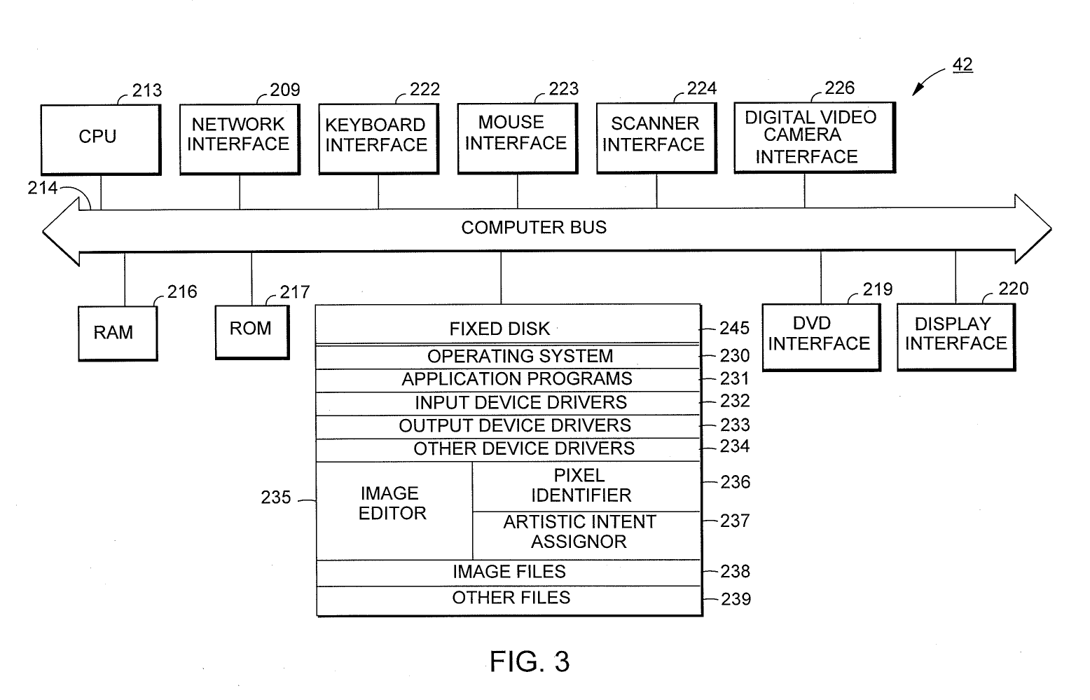

FIG. 3 is a detailed block diagram showing the internal architecture of second host computer 42. As shown in FIG. 3, second host computer 42 includes central processing unit (CPU) 213 which may be a multi-core CPU and which interfaces with computer bus 214. Also interfacing with computer bus 214 are hard disk 245, network interface 209, random access memory (RAM) 216 for use as a main run-time transient memory, read only memory (ROM) 217, DVD disk interface 219, display interface 220 for display screen 52, keyboard interface 222 for a keyboard, mouse interface 223 for a pointing device, scanner interface 224 for scanner 70, and digital video camera interface 226 for digital video camera 60.

RAM 216 interfaces with computer bus 214 so as to provide information stored in RAM 216 to CPU 213 during execution of the instructions in software programs such as an operating system, application programs, color management modules, and device drivers. More specifically, CPU 213 first loads computer-executable process steps from fixed disk 245, or another storage device into a region of RAM 216. CPU 213 can then execute the stored process steps from RAM 216 in order to execute the loaded computer-executable process steps. Data such as color images or other information can be stored in RAM 216, so that the data can be accessed by CPU 213 during the execution of computer-executable software programs, to the extent that such software programs have a need to access and/or modify the data.

As also shown in FIG. 3, fixed disk 245 contains computer-executable process steps for operating system 230, and application programs 231, such as graphic image management programs and other editing and coloring tools. Fixed disk 245 also contains computer-executable process steps for device drivers for software interface to devices, such as input device drivers 232, output device drivers 233, and other device drivers 234. Image files 238, including color image files, and other files 239 are available for output to color output devices and for manipulation by application programs.

Fixed disk 245 also contains computer-executable process steps for image editor 235 which includes pixel identifier 236 and artistic intent assignor 237. Generally, image editor 235 identifies an artistic intent for each pixel of the image, and stores information identifying the artistic intent for each pixel of the image in a format that stores the artistic intent identification information together with the image data for each pixel of the image. In this embodiment, the artistic intent is constituted by chained application of one or more of the look algorithms.

More specifically, pixel identifier 236 is constructed to access the image, and to identify pixels of the image to which an artistic intent will be assigned. The image is either a still or moving image, and is captured by a digital camera or digital video camera 60. Alternatively, the image may be captured using a non-digital device, and thereafter converted to a digital format by using scanner 70. Of course, the image may also be accessed through a USB device, a network interface, or any other suitable medium. The operation of pixel identifier 236 is discussed in further detail below, with reference to FIG. 6.

Artistic intent assignor 237 is constructed to select and assign the artistic intent to each identified pixel of the image. The operation of artistic intent assignor 237 is discussed in further detail below, with reference to FIG. 6.

In some embodiments, a look management system processes the input image after the artistic intent is assigned for a pixel in order to incorporate all of the artistic intent assignments made to the pixels of the image, and displays the result on display screen 52. This preview process is repeated until all desired assignments are made to each identified pixel of the image.

The information identifying the artistic intent for each pixel of the image is stored in an enhanced format that stores the artistic intent identification information together with the image data for each pixel of the image.

In this embodiment, when the image is edited using editing tools and/or coloring tools within the production chain, the tools modify the color of each such pixel using the artistic intent identification information stored for each pixel. Alternatively, the artistic intent identification information stored for each pixel can be modified during editing based on additional information provided post-capture or during post-production.

Furthermore, when the image is one frame among multiple frames of a moving image, situations arise in which pixels for an object appear across multiple frames of the moving image. In this case, artistic intent assignor 237 identifies the same artistic intent for all such pixels. Moreover, situations arise in which there are multiple different objects that appear across multiple frames of the moving image, such that each object is considered to have its own look. In this case, artistic intent assignor 237 identifies a different artistic intent for each object, such that the complex artistic intent is preserved.

For example, a moving image may capture a scene in which a first actor is angry and a second actor is frightened. In this situation, a first artistic intent is identified for all of the pixels for the first actor's face across multiple moving frames, and a second, different, artistic intent is identified for all of the pixels for the second actor's face across multiple moving frames. The artistic intent identified for the pixels of the first actor's face is constituted by one or more look algorithms which increase the amount of red, such that the first actor's face appears red from anger. On the other hand, the artistic intent identified for the pixels of the second actor's face is constituted by one or more look algorithms which make the second actor's face appear more pale, such that he appears frightened. Thus, because the artistic intent is identified on a per-pixel basis, it becomes possible to treat each object with a different color adjustment, regardless of whether the original colors of the objects share similar color values.

The computer-executable process steps for image editor 235 may be configured as a part of operating system 130, as part of a device driver, or as a stand-alone application program such as a look management application. They may also be configured as a plug-in or dynamic link library (DLL) to the operating system, device driver or application program. For example, image editor 235 according to example embodiments may be incorporated in an output device driver for execution in a computing device, such as a camera driver, embedded in the firmware of an input device, such as a camera, or provided in a stand-alone look management application for use on a general purpose computer. In one example embodiment described herein, image editor 235 is incorporated directly into the operating system for second host computer 42. It can be appreciated that the present disclosure is not limited to these embodiments and that the disclosed module may be used in other environments in which artistic intent is used.

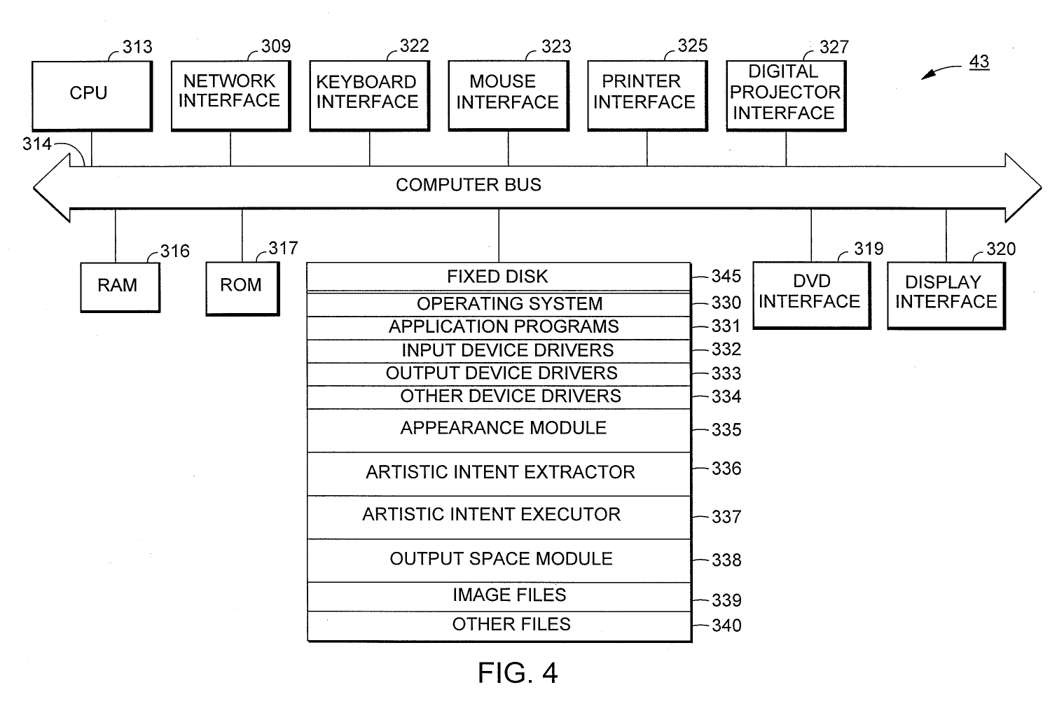

FIG. 4 is a detailed block diagram showing the internal architecture of third host computer 43. As shown in FIG. 4, third host computer 43 includes central processing unit (CPU) 313 which may be a multi-core CPU and which interfaces with computer bus 314. Also interfacing with computer bus 314 are hard disk 345, network interface 309, random access memory (RAM) 316 for use as a main run-time transient memory, read only memory (ROM) 317, DVD disk interface 319, display interface 320 for display screen 53, keyboard interface 322 for a keyboard, mouse interface 323 for a pointing device, printer interface 325 for printer 90, and digital projector interface 327 for digital projector 50.

RAM 316 interfaces with computer bus 314 so as to provide information stored in RAM 316 to CPU 313 during execution of the instructions in software programs such as an operating system, application programs, color management modules, and device drivers. More specifically, CPU 313 first loads computer-executable process steps from fixed disk 345, or another storage device into a region of RAM 316. CPU 313 can then execute the stored process steps from RAM 316 in order to execute the loaded computer-executable process steps. Data such as color images or other information can be stored in RAM 316, so that the data can be accessed by CPU 313 during the execution of computer-executable software programs, to the extent that such software programs have a need to access and/or modify the data.

As also shown in FIG. 4, fixed disk 345 contains computer-executable process steps for operating system 330, and application programs 331, such as graphic image management programs. Fixed disk 345 also contains computer-executable process steps for device drivers for software interface to devices, such as input device drivers 332, output device drivers 333, and other device drivers 334. Image files 339, including color image files, and other files 340 are available for output to color output devices and for manipulation by application programs.

Fixed disk 345 also contains computer-executable process steps for appearance module 335, artistic intent extractor 336, artistic intent executor 337 and output space module 338. Together, these modules comprise a module for using complex artistic intent for an image having image data for multiple pixels, where plural look algorithms are defined, and each look algorithm applies color adjustments to one or more colors to produce corresponding output colors. An artistic intent for each pixel of the image is identified, the artistic intent being constituted by chained application of one or more of the look algorithms. Information identifying the artistic intent for each pixel of the image is stored in a format that stores the artistic intent identification information together with the image data for each pixel of the image.

Generally, an output device such as printer 90 or projector 50 is specified, and colors of the image are converted to colors that can be represented in the specified output device by reference to the artistic intent identification information stored for each pixel in the image, so as to preserve complex artistic intent on the specified output device. Other examples of output devices include, at least, film recorders and other non-digital and digital media.

More particularly, appearance module 335 is constructed to access each pixel of the moving or still image, and to convert color information of each pixel of the image to a color appearance value. Artistic intent extractor 336 is constructed to extract the stored information identifying the artistic intent for each pixel of the image.

Artistic intent executor 337 is constructed to execute the one or more look algorithms constituting the artistic intent for each corresponding pixel, and the look algorithms apply color adjustments to the color appearance value of each corresponding pixel to produce corresponding output colors. Output space module 338 is constructed to convert the corresponding output colors to colors that can be represented in the specified output device.

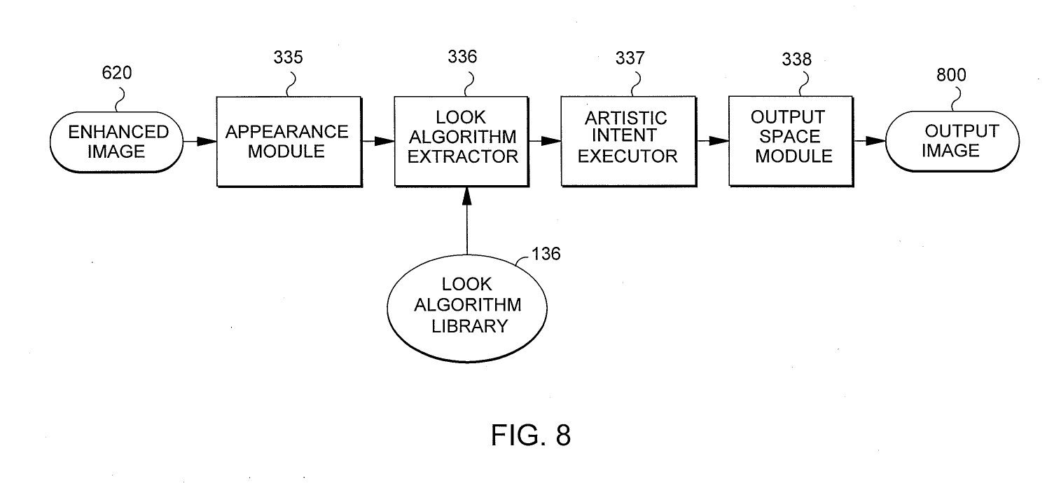

The operation of appearance module 335, artistic intent extractor 336, artistic intent executor 337 and output space module 338 is discussed in further detail below with reference to FIG. 8.

The computer-executable process steps for appearance module 335, artistic intent extractor 336, artistic intent executor 337 and output space module 338 may be configured as a part of operating system 130, as part of a device driver, or as a stand-alone application program such as a look management system. They may also be configured as a plug-in or dynamic link library (DLL) to the operating system, device driver or application program. For example, appearance module 335, artistic intent extractor 336, artistic intent executor 337 and output space module 338, according to example embodiments, may be incorporated in an output device driver for execution in a computing device, such as a printer driver, embedded in the firmware of an output device, such as a printer, or provided in a stand-alone look management application for use on a general purpose computer. In one example embodiment described herein, appearance module 335, artistic intent extractor 336, artistic intent executor 337 and output space module 338 are incorporated directly into the operating system for third host computer 43. It can be appreciated that the present disclosure is not limited to these embodiments and that the disclosed modules may be used in other environments in which artistic intent is used.

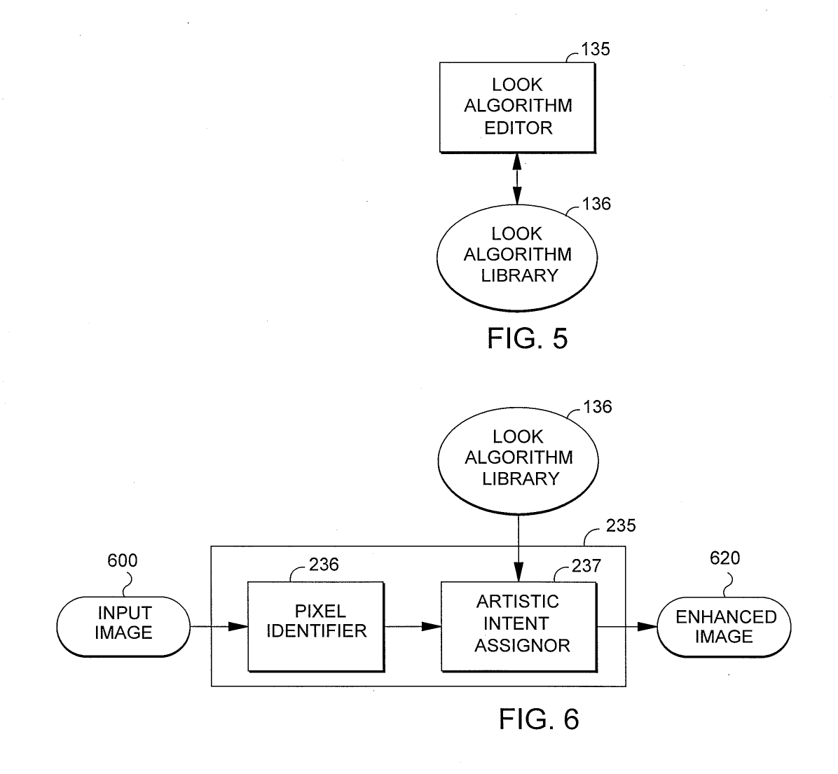

FIG. 5 is a view for explaining software architecture of look algorithm editor module 135. Look algorithm editor 135 is constructed to define plural look algorithms, each of which applies color adjustments to one or more colors to produce corresponding output colors. More specifically, look algorithm editor 135 accesses look algorithm library 136 in order to edit an existing look algorithm which is stored in look algorithm library 136, or to create and store a new look algorithm in look algorithm library 136.

FIG. 6 is a view for explaining software architecture of image editor module 235. As previously discussed with respect to FIG. 3, image editor 235 identifies an artistic intent for each pixel of the image, and stores information identifying the artistic intent for each pixel of the image in an enhanced format that stores the artistic intent identification information together with the image data for each pixel of the image. In this embodiment, the artistic intent is constituted by chained application of one or more of the look algorithms.

Image editor module 235 comprises a pixel identifier 236 is constructed to access the image, and to identify pixels of the image. More specifically, in this embodiment, pixel identifier 236 identifies each pixel of the image, and selects one or more pixels in order to generate a list of pixels to which artistic intents will be assigned. The selection of pixels can be based on a variety of techniques, including, for example, selection by a user, object recognition techniques and feature detection techniques, or a combination thereof.

Artistic intent assignor 237 is constructed to select and assign the artistic intent to each identified pixel of the image. More particularly, artistic intent assignor 237 accesses look algorithm library 136 in order to select an artistic intent from the plural look algorithms stored in look algorithm library 136 for a corresponding pixel identified by pixel identifier 236. Artistic intent assignor 237 then assigns the selected artistic intent algorithm to the corresponding pixel. This process is repeated until an artistic intent is assigned to each identified pixel on the list. In this embodiment, the artistic intent is selected and assigned by using a graphical user interface which is displayed on display screen 52. Alternatively, a non-graphical user interface may be used. In other embodiments, artistic intent assignor 237 selects and assigns the artistic intent based on a set of parameters, or alternatively selects the artistic intent based on a combination of user input and the set of parameters.

In this embodiment, if there are pixels of the image that are not identified by pixel identifier 236, such pixels are assigned information indicating that no artistic intent is identified for that particular pixel.

The image is stored as enhanced image 620 in a format which includes information identifying the artistic intent together with the image data for each pixel of the image. In this example embodiment, information identifying the artistic intent is stored for each pixel of the image, and the one or more look algorithms which constitute the artistic intent are stored in look algorithm library 136. In other embodiments, the look algorithms are stored in the image itself, for example, in the metadata of the image.

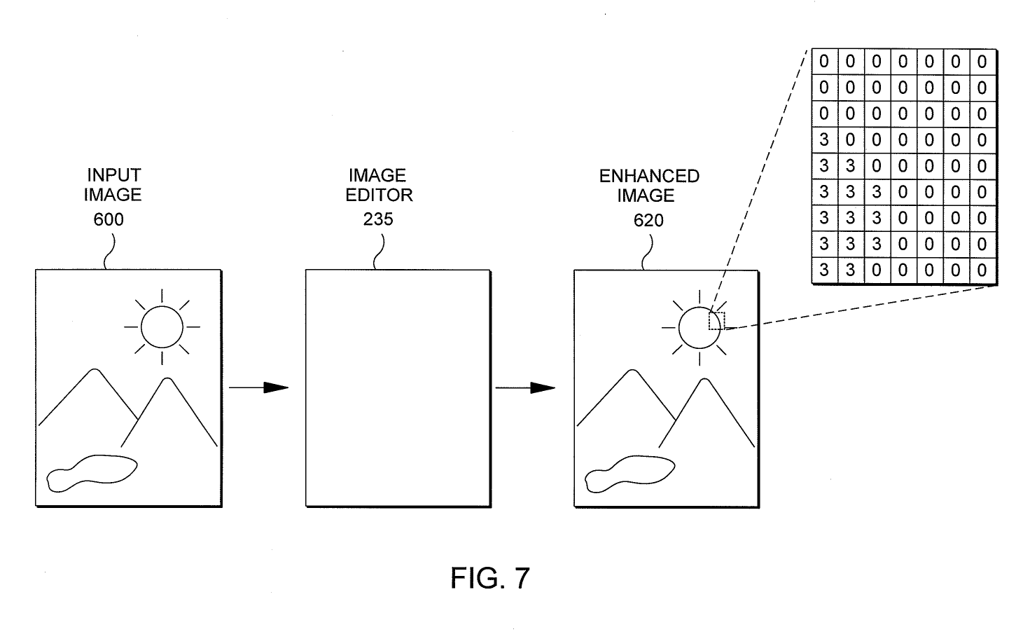

FIG. 7 is a representational view of processing performed by image editor 235. As discussed above in reference to FIG. 6, image editor 235 accesses input image 600 and identifies an artistic intent for each pixel of input image 600 in order to output enhanced image 620, which stores information identifying the artistic intent for each pixel of the image together with the image data for each pixel of the image. Thus, in this embodiment, enhanced image 620 is stored in a format that includes three color channels and an artistic look channel for each pixel of the still or moving image. FIG. 7 shows the enhanced format including three color channels and an artistic look channel for each pixel of a portion of enhanced image 620. Alternatively, in other embodiments, information identifying the artistic intent can be stored as metadata of the image.

As shown in FIG. 7, in this embodiment, the artistic intent identification information is represented by a numeric element, such as the numeral “3” or the numeral “0”. This information is used as an index and indicates that the one or more look algorithms stored in look library 136 which constitute artistic intent “3” should be applied to that particular pixel. Pixels designated with the numeric element “0” are interpreted to have no special artistic intent assigned. Of course, this identification system is merely one suitable implementation, and other suitable representations may be used.

FIG. 8 is a view for explaining software architecture of modules for using complex artistic intent. These modules include appearance module 335, artistic intent extractor 336, artistic intent executor 337 and output space module 338. Appearance module 335 accesses enhanced image 620 in order to convert color information of each pixel of the enhanced image 620 to a color appearance value.

Artistic intent extractor 336 receives the color appearance values of enhanced image 620 from appearance module 335, and extracts the stored information identifying the artistic intent for each pixel of the image by accessing look algorithm library 136. More specifically, artistic intent extractor 336 extracts the artistic intent identification information for each pixel of the image, for example, the numeric element 3, and references look algorithm library 136 in order to extract the one or more look algorithms corresponding to the artistic intent identification information. In this embodiment, artistic intent extractor 336 loads the one or more look algorithms from look algorithm library 136 for execution by artistic intent executor 337. Alternatively, in the case that look algorithms are stored in the image metadata, artistic intent extractor 336 loads the one or more look algorithms from the image metadata for execution by artistic intent executor 337.

Artistic intent executor 337 receives the extracted information from artistic intent extractor 336, and executes the one or more look algorithms constituting the artistic intent for each corresponding pixel in order to produce corresponding output colors. In particular, each look algorithm applies color adjustments to the color appearance value of each corresponding pixel.

Output space module 338 receives the adjusted color data for each pixel of the image from artistic intent executor 337 and converts the corresponding output colors to colors that can be represented in the specified output device in order to output image 800 for rendering on the specified output device.

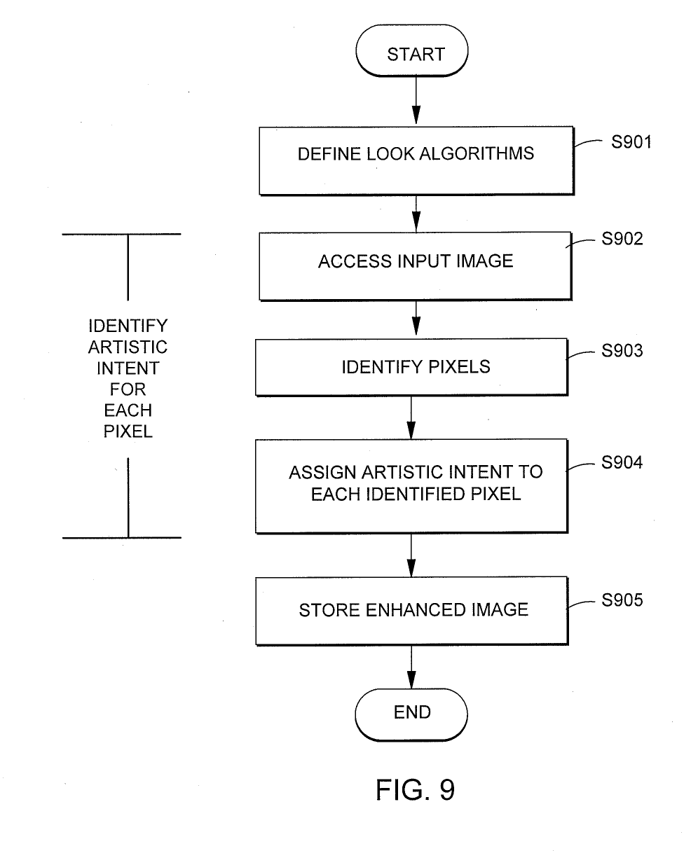

FIG. 9 is a flow diagram for explaining capturing complex artistic intent for an image according to an example embodiment. The process steps shown in FIG. 9 are computer-executable process steps stored on a computer-readable memory medium. According to the process steps shown in FIG. 9, plural look algorithms are defined by look algorithm editor 135 and stored in look algorithm library 136 in step S901.

In steps S902 to steps S904, an artistic intent for each pixel of the image is identified by image editor 235, where the artistic intent is constituted by chained application of one or more of the look algorithms stored in look algorithm library 136. In more detail, pixel identifier 236 accesses input image 600 in step S902, and identifies pixels of image 600 in step S903 by generating a list of pixels to which an artistic intent will be assigned. As previously discussed, this list is generated based on one or more of selection by a user, objection recognition techniques, or feature detection techniques.

In step S904, artistic intent assignor 237 receives the list of identified pixels from pixel identifier 236 and accesses look algorithm library 136 in order to select and assign an artistic intent for each identified pixel of image 600. As previously discussed, the artistic intent is selected and assigned based on at least one of input received through a graphical or non-graphical user interface and a set of parameters. The remaining pixels of the image which are not identified by pixel identifier 236 are assigned information indicating that no artistic intent has been selected.

The flow then proceeds to step S905 in which information identifying the artistic intent for each pixel of the image is stored as enhanced image 620 in a format that stores the artistic intent identification information together with the image data for each pixel of the image.

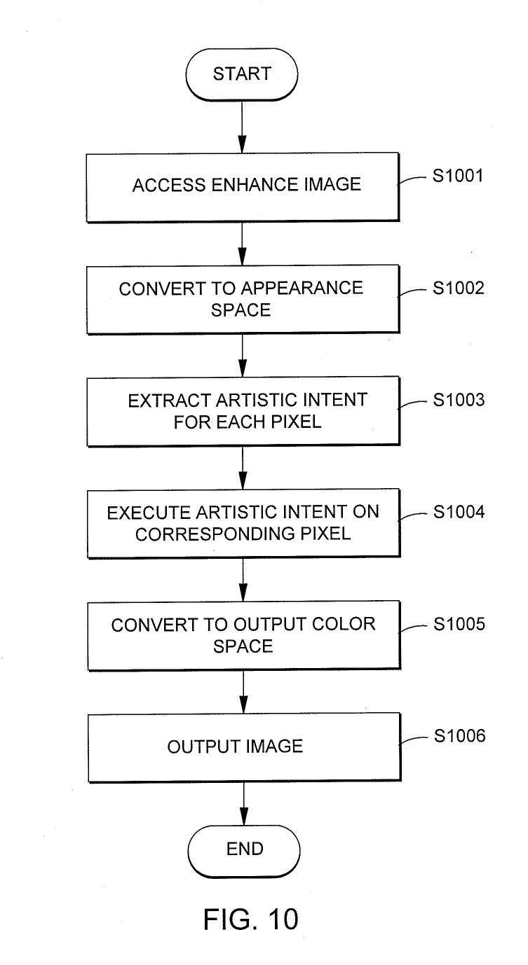

FIG. 10 is a flow diagram for explaining using complex artistic intent for an image according to an example embodiment. The process steps shown in FIG. 10 are computer-executable process steps stored on a computer-readable memory medium.

In step S1001, enhanced image 620 is accessed by appearance module 335, and in step S1002 the color values for each pixel of enhanced image 620 are converted to appearance space by appearance module 335. The flow then proceeds to step S1003 in which artistic intent extractor 336 extracts the stored information identifying the artistic intent for each pixel of the image with reference to look algorithm library 136. In step S1004, artistic intent executor 337 applies the artistic intent extracted by artistic intent extractor 336 by executing the one or more look algorithms constituting the artistic intent for each corresponding pixel. More specifically, each executed look algorithm applies color adjustments to the color appearance value of each corresponding pixel to produce corresponding output colors. In step S1005, output space module 338 converts the corresponding output colors received from artistic intent executor 337 to colors that can be represented in the color space of the specified output device. The flow the proceeds to step S1006 in which the resulting image 800 is output to the specified output device for rendering.

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method for capturing complex artistic intent for an image having image data for multiple pixels, the method comprising:
defining plural look algorithms, wherein each look algorithm applies color adjustments to one or more colors to produce corresponding output colors;
identifying an artistic intent for each pixel of the image, wherein the artistic intent is constituted by chained application of one or more of the look algorithms; and
storing information identifying the artistic intent for each pixel of the image in a format that stores the artistic intent identification information together with the image data for each pixel of the image.

2. The method according to claim 1, wherein each look algorithm is encoded in an interpretive language.

3. The method according to claim 1, wherein each look algorithm is represented as a look up table.

4. A method according to claim 1, the method further comprising:
accessing the image;
identifying pixels of the image; and
selecting and assigning the artistic intent to each identified pixel of the image.

5. A method according to claim 1, wherein the method further comprises editing of the image, wherein during editing the artistic intent identification information stored for each pixel is used to modify the color of each such pixel.

6. A method according to claim 1, wherein the method further comprises editing of the image, wherein during editing the artistic intent identification information stored for each pixel is modified.

7. A method according to claim 1, wherein the method further comprises rendering of the image for a specified output device, wherein during rendering colors in the image are converted to colors that can be represented in the specified output device by reference to the artistic intent identification information stored for each pixel in the image, so as to preserve artistic intent on the specified output device.

8. A method according to claim 1, wherein the image is one frame among multiple frames of a moving image, and wherein each of the multiple frames has image data for multiple pixels.

9. A method according to claim 8, wherein the method further comprises designating of pixels for an object that appears across multiple frames of the moving image, wherein the same artistic intent is identified for all such pixels.

10. A method according to claim 9, wherein there are multiple different objects that appear across multiple frames of the moving image, and a different artistic intent is identified for each object.

11. A method for using complex artistic intent for an image having image data for multiple pixels, wherein plural look algorithms are defined, wherein each look algorithm applies color adjustments to one or more colors to produce corresponding output colors, wherein an artistic intent for each pixel of the image is identified, wherein the artistic intent is constituted by chained application of one or more of the look algorithms, and wherein information identifying the artistic intent for each pixel of the image is stored in a format that stores the artistic intent identification information together with the image data for each pixel of the image, the method comprising:
converting color information of each pixel of the image to a color appearance value;
extracting the stored information identifying the artistic intent for each pixel of the image;
executing the one or more look algorithms constituting the artistic intent for each corresponding pixel, wherein the look algorithms apply color adjustments to the color appearance value of each corresponding pixel to produce corresponding output colors;
converting the corresponding output colors to colors that can be represented in a specified output device.

12. A method according to claim 11, wherein the image is one frame among multiple frames of a moving image, and wherein each of the multiple frames has image data for multiple pixels.

13. A module for capturing complex artistic intent for an image having image data for multiple pixels, the module comprising:
an image editor module constructed to identify an artistic intent for each pixel of the image, wherein the artistic intent is constituted by chained application of one or more look algorithms, and to store information identifying the artistic intent for each pixel of the image in a format that stores the artistic intent identification information together with the image data for each pixel of the image,
wherein the look algorithms are defined by a look algorithm editor module constructed to define plural look algorithms, wherein each look algorithm applies color adjustments to one or more colors to produce corresponding output colors.

14. The module according to claim 13, wherein each look algorithm is encoded in an interpretive language.

15. The module according to claim 13, wherein each look algorithm is represented as a look up table.

16. A module according to claim 13, wherein the image editor module comprises:
a pixel identifier module constructed to access the image, and to identify pixels of the image; and
an artistic intent assignor module constructed to select and assign the artistic intent to each identified pixel of the image.

17. A module according to claim 13, wherein the image is edited, and wherein during editing the artistic intent identification information stored for each pixel is used to modify the color of each such pixel.

18. A module according to claim 13, wherein the image is edited, and wherein during editing the artistic intent identification information stored for each pixel is modified.

19. A module according to claim 13, wherein the image is rendered for a specified output device, and wherein during rendering colors in the image are converted to colors that can be represented in the specified output device by reference to the artistic intent identification information stored for each pixel in the image, so as to preserve artistic intent on the specified output device.

20. A module according to claim 13, wherein the image is one frame among multiple frames of a moving image, and wherein each of the multiple frames has image data for multiple pixels.

21. A module according to claim 20, wherein pixels for an object that appears across multiple frames of the moving image, and wherein the same artistic intent is identified for all such pixels.

22. A module according to claim 21, wherein there are multiple different objects that appear across multiple frames of the moving image, and a different artistic intent is identified for each object.

23. A module for using complex artistic intent for an image having image data for multiple pixels, wherein plural look algorithms are defined, wherein each look algorithm applies color adjustments to one or more colors to produce corresponding output colors, wherein an artistic intent for each pixel of the image is identified, wherein the artistic intent is constituted by chained application of one or more of the look algorithms, and wherein information identifying the artistic intent for each pixel of the image is stored in a format that stores the artistic intent identification information together with the image data for each pixel of the image, the module comprising:
an appearance module constructed to convert color information of each pixel of the image to a color appearance value;
an extraction module constructed to extract the stored information identifying the artistic intent for each pixel of the image;
an execution module constructed to execute the one or more look algorithms constituting the artistic intent for each corresponding pixel, wherein the look algorithms apply color adjustments to the color appearance value of each corresponding pixel to produce corresponding output colors; and
an output module constructed to convert the corresponding output colors to colors that can be represented in a specified output device.

24. A module according to claim 23, wherein the image is one frame among multiple frames of a moving image, and wherein each of the multiple frames has image data for multiple pixels.

25. An apparatus for capturing complex artistic intent for an image having image data for multiple pixels, the apparatus comprising:
a computer-readable memory constructed to store computer-executable process steps; and
a processor constructed to execute the computer-executable process steps stored in the memory;
wherein the process steps include computer-executable process steps to:
identify an artistic intent for each pixel of the image, wherein the artistic intent is constituted by chained application of one or more look algorithms; and
store information identifying the artistic intent for each pixel of the image in a format that stores the artistic intent identification information together with the image data for each pixel of the image,
wherein plural look algorithms are defined, and wherein each look algorithm applies color adjustments to one or more colors to produce corresponding output colors.

26. The apparatus according to claim 25, wherein each look algorithm is encoded in an interpretive language.

27. The apparatus according to claim 25, wherein each look algorithm is represented as a look up table.

28. An apparatus according to claim 25, the process steps further include computer-executable process steps to:
access the image;
identify pixels of the image; and
select and assign the artistic intent to each identified pixel of the image.

29. An apparatus according to claim 25, wherein the image is edited, wherein during editing the artistic intent identification information stored for each pixel is used to modify the color of each such pixel.

30. An apparatus according to claim 25, wherein the image is edited, wherein during editing the artistic intent identification information stored for each pixel is modified.

31. An apparatus according to claim 25, wherein the process steps further include computer-executable process steps to render the image for a specified output device, wherein during rendering colors in the image are converted to colors that can be represented in the specified output device by reference to the artistic intent identification information stored for each pixel in the image, so as to preserve artistic intent on the specified output device.

32. An apparatus according to claim 25, wherein the image is one frame among multiple frames of a moving image, and wherein each of the multiple frames has image data for multiple pixels.

33. An apparatus according to claim 32, wherein the process steps further include computer-executable process steps to designate pixels for an object that appears across multiple frames of the moving image, wherein the same artistic intent is identified for all such pixels.

34. An apparatus according to claim 33, wherein there are multiple different objects that appear across multiple frames of the moving image, and a different artistic intent is identified for each object.

35. An apparatus for using complex artistic intent for an image having image data for multiple pixels, wherein plural look algorithms are defined, wherein each look algorithm applies color adjustments to one or more colors to produce corresponding output colors, wherein an artistic intent for each pixel of the image is identified, wherein the artistic intent is constituted by chained application of one or more of the look algorithms, and wherein information identifying the artistic intent for each pixel of the image is stored in a format that stores the artistic intent identification information together with the image data for each pixel of the image, the apparatus comprising:
a computer-readable memory constructed to store computer-executable process steps; and
a processor constructed to execute the computer-executable process steps stored in the memory;
wherein the process steps include computer-executable process steps to:
convert color information of each pixel of the image to a color appearance value;
extract the stored information identifying the artistic intent for each pixel of the image;
execute the one or more look algorithms constituting the artistic intent for each corresponding pixel, wherein the look algorithms apply color adjustments to the color appearance value of each corresponding pixel to produce corresponding output colors; and
convert the corresponding output colors to colors that can be represented in a specified output device.

36. An apparatus according to claim 35, wherein the image is one frame among multiple frames of a moving image, and wherein each of the multiple frames has image data for multiple pixels.

37. A computer-readable memory medium on which is stored computer-executable process steps for capturing complex artistic intent for an image having image data for multiple pixels, the process steps comprising:
identifying an artistic intent for each pixel of the image, wherein the artistic intent is constituted by chained application of one or more of the look algorithms; and
storing information identifying the artistic intent for each pixel of the image in a format that stores the artistic intent identification information together with the image data for each pixel of the image,
wherein plural look algorithms are defined, and wherein each look algorithm applies color adjustments to one or more colors to produce corresponding output colors.

38. The computer-readable memory medium according to claim 37, wherein each look algorithm is encoded in an interpretive language.

39. The computer-readable memory medium according to claim 37, wherein each look algorithm is represented as a look up table.

40. A computer-readable memory medium according to claim 37, wherein the process steps further comprise:
accessing the image;
identifying pixels of the image; and
selecting and assigning the artistic intent to each identified pixel of the image.

41. A computer-readable memory medium according to claim 37, wherein the process steps further comprise editing of the image, wherein during editing the artistic intent identification information stored for each pixel is used to modify the color of each such pixel.

42. A computer-readable memory medium according to claim 37, wherein the process steps further comprise editing of the image, wherein during editing the artistic intent identification information stored for each pixel is modified.

43. A computer-readable memory medium according to claim 37, wherein the process steps further comprise rendering of the image for a specified output device, wherein during rendering colors in the image are converted to colors that can be represented in the specified output device by reference to the artistic intent identification information stored for each pixel in the image, so as to preserve artistic intent on the specified output device.

44. A computer-readable memory medium according to claim 37, wherein the image is one frame among multiple frames of a moving image, and wherein each of the multiple frames has image data for multiple pixels.

45. A computer-readable memory medium according to claim 44, wherein the process steps further comprise designating of pixels for an object that appears across multiple frames of the moving image, wherein the same artistic intent is identified for all such pixels.

46. A computer-readable memory medium according to claim 45, wherein there are multiple different objects that appear across multiple frames of the moving image, and a different artistic intent is identified for each object.

47. A computer-readable memory medium on which is stored computer-executable process steps for using complex artistic intent for an image having image data for multiple pixels, wherein plural look algorithms are defined, wherein each look algorithm applies color adjustments to one or more colors to produce corresponding output colors, wherein an artistic intent for each pixel of the image is identified, wherein the artistic intent is constituted by chained application of one or more of the look algorithms, and wherein information identifying the artistic intent for each pixel of the image is stored in a format that stores the artistic intent identification information together with the image data for each pixel of the image, the process steps comprising:
converting color information of each pixel of the image to a color appearance value;
extracting the stored information identifying the artistic intent for each pixel of the image;
executing the one or more look algorithms constituting the artistic intent for each corresponding pixel, wherein the look algorithms apply color adjustments to the color appearance value of each corresponding pixel to produce corresponding output colors; and
converting the corresponding output colors to colors that can be represented in a specified output device.

48. A computer-readable memory medium according to claim 47, wherein the image is one frame among multiple frames of a moving image, and wherein each of the multiple frames has image data for multiple pixels.
